(19) United States
(12) Patent Application Publication
(10) Pub. No.: US 2011/0297717 A1
(43) Pub. Date: Dec. 8, 2011

(54) HOLDER FOR A BEVERAGE CONTAINER

(75) Inventor: Hartwig Kaemmer, Waldachtal (DE)

(73) Assignee: FISCHER AUTOMOTIVE SYSTEMS GMBH & CO. KG, Horb (DE)

(21) Appl. No.: 13/154,472

(22) Filed: Jun. 7, 2011

(30) Foreign Application Priority Data
Jun. 7, 2010 (DE) 10 2010 017 249.9

(51) Int. Cl. B60R 7/00

(52) U.S. Cl. 224/567

(57) ABSTRACT

A holder for a beverage container includes a container receptacle configured to receive a beverage container, a separate base disposed in the container receptacle and at least one holding jaw formed in a single piece with the base. The holding jaw is inwardly resilient and pressable toward an outside of the container receptacle.

### CROSS REFERENCE TO RELATED APPLICATIONS

This application claims priority to German Patent Application No. DE 10 2010 017 249.9, filed Jun. 7, 2010, which is incorporated by reference herein in its entirety.

### FIELD

The invention relates to a holder for a beverage container such as, for instance, beverage cans, mugs, cups or bottles in vehicles, especially in motor vehicles.

### BACKGROUND

A holder for a beverage container is described in European patent application EP 1 366 952 A2. The holder has a bowl-shaped container receptacle that is open towards the top so that a beverage container can be placed there. In this context, the spatial direction “top” refers to a prescribed installation position of the holder. The holder has holding jaws around its circumference that protrude into the container receptacle through openings in an encircling wall of the container receptacle. The holding jaws are pressed resiliently into the container receptacle and can be pressed away towards the outside against the spring force. When a beverage container is placed into the container receptacle, it presses the holding jaws outwards which, due to the spring force exerted on them, lie resiliently against the outer circumference of the beverage container that has been placed into the beverage receptacle. The holding jaws on which the spring force is being exerted make the beverage container placed into the beverage receptacle less likely to tip over, and their resilience allows them to adapt automatically to the diameter of the beverage container. The term “holding jaw” is to be construed in the general sense of an element on which a spring force is being exerted towards the inside of the beverage receptacle, said element being laterally in contact with a beverage container that has been placed there in order to hold the beverage container more securely in the beverage receptacle and to prevent it from tipping over.

The holding jaws of the holder are provided on free, upper ends of spring elements that are in the form of leaf springs and that protrude upwards on the outside of the encircling wall of the container receptacle. The spring elements of this holder are arranged at an angle underneath the base of the container receptacle, they are attached in one piece to each other, and they are fastened to the bottom of the base.

### SUMMARY

An aspect of the present invention is to provide a holder for a beverage container of the above-mentioned type, which includes few individual parts that are easy to produce and to assemble.

In an embodiment, the present invention provides a holder for a beverage container including a container receptacle configured to receive a beverage container, a separate base disposed in the container receptacle and at least one holding jaw formed in a single piece with the base. The holding jaw is inwardly resilient and pressable toward an outside of the container receptacle.

### BRIEF DESCRIPTION OF THE DRAWINGS

Exemplary embodiments of the present invention are described in greater detail below with reference to the drawings, in which:

FIG. 1 shows a holder according to the invention, with a beverage container that has been placed therein, in a perspective view;

FIG. 2 shows the holder of FIG. 1, without a beverage container;

FIG. 3 shows individual parts of the holder of FIGS. 1 and 2, in an exploded view; and

FIG. 4 shows an axial section of the holder of FIGS. 1 to 3.

### DETAILED DESCRIPTION

A holder according to an embodiment of the invention has a base that is arranged on the container receptacle. The base forms a resting surface for a beverage container that has been placed into the container receptacle. The invention does not rule out that the container receptacle has an additional base on which the other base rests, or else together, they form a surface. The at least one holding jaw is formed in a single piece with the base, so that in the simplest case, the holder according to the invention consists of two parts, namely, the container receptacle and the base with the at least one resilient holding jaw. The assembly can be carried out by simply placing or inserting the base into the container receptacle.

Preferably, the base can be detachably arranged on the container receptacle. This allows not only a simple assembly but also, for example, that the base can be removed from the container receptacle of the holder according to the invention for cleaning purposes.

Preferably, the holder has several resilient holding jaws that are distributed uniformly or non-uniformly along the circumference of the container receptacle.

A preferred embodiment of the invention provides that the base that can be detached from the container receptacle has a drip tray, for example, in the form of a drip tray having an encircling rim that extends upwards. Here, the term “drip tray” is to be understood in the general sense of a collecting element for liquid that spills out of the beverage container and ends up in the container receptacle. In particular, the fact that the base can be removed from the container receptacle simplifies the cleaning procedure.

One embodiment of the invention provides that the at least one holding jaw has a spring element that extends upwards from the base in a circumferential area of the container receptacle. The spring element is formed in a single piece with the base while the holding jaw is formed in a single piece with the spring element. This embodiment of the invention allows a simple production of the base with one or more spring elements in a single piece, in each case with a holding jaw, and made, for instance, of sheet metal as a stamped or bent part, or else of plastic, for instance, by means of injection molding. The beverage receptacle of the holder is assembled by simply inserting the base together with the spring element(s) and the holding jaws into the container receptacle.

One embodiment of the invention provides that the spring element is supported towards the outside on the container receptacle. This support towards or from the outside accounts for a good, resilient contact of the holding jaws from the outside with the circumference of a beverage container that has been placed into the container receptacle.

One embodiment of the invention provides for a resilient curved piece as the spring element. This resilient curved piece can be, for example, in the form of a curved leaf spring. This embodiment of the invention allows a simple spring element that is adapted to the invention.

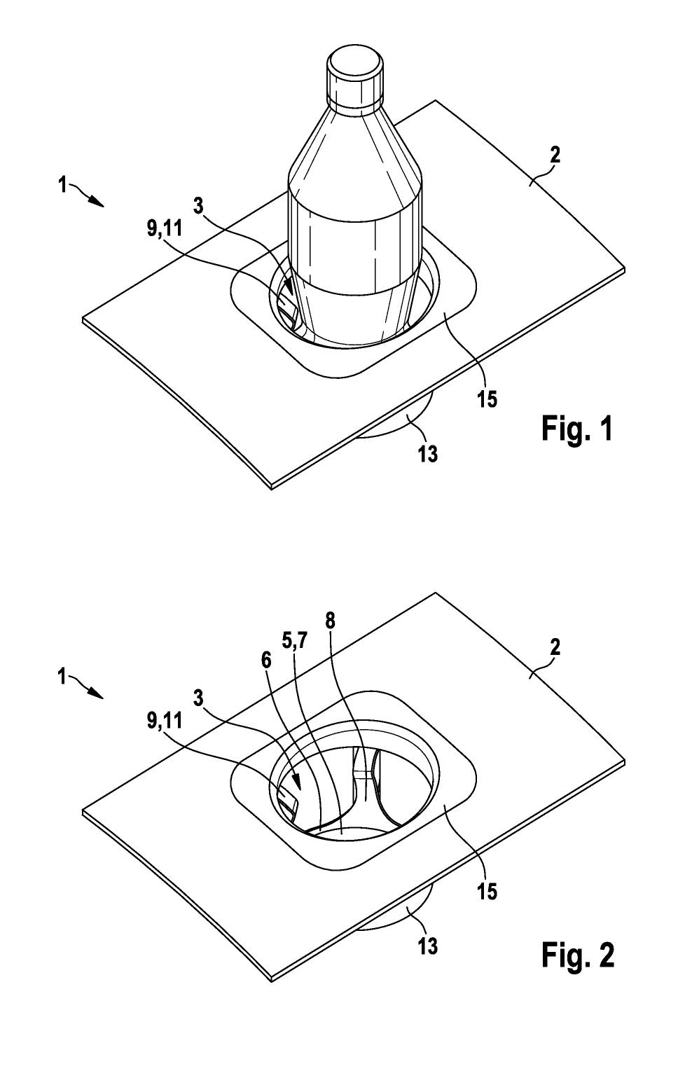

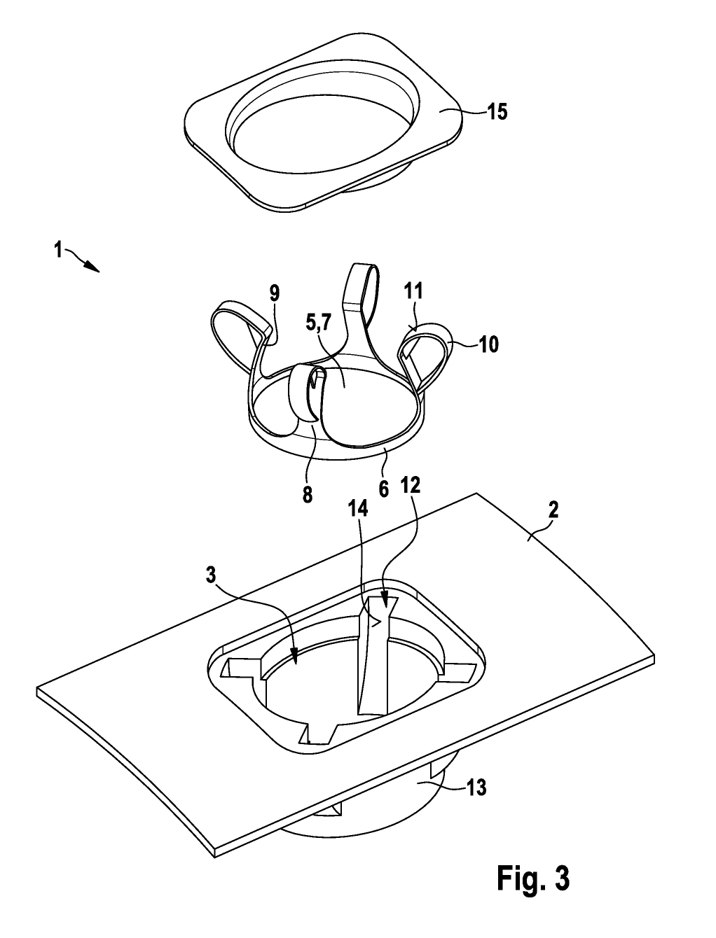

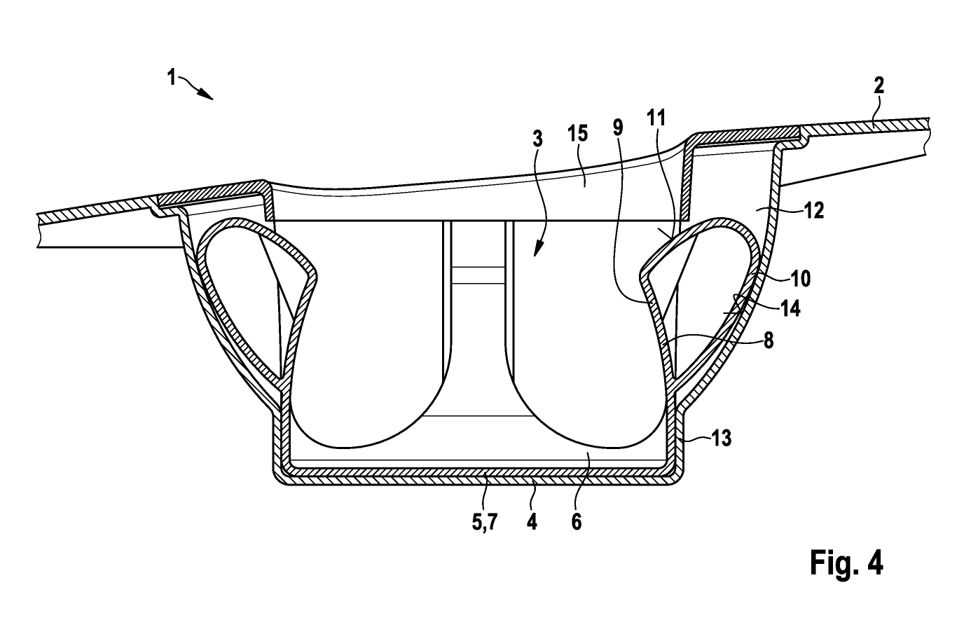

The holder 1 shown in the drawing is intended to allow a beverage container in a vehicle to be put in place and held so that it cannot tip over. The beverage container can be a bottle, as shown in FIG. 1, or else a mug, a cup or a beverage can. The holder 1 is installed in an approximately horizontal surface, for instance, in the center console 2 of an automobile not otherwise shown here. A portion of the approximately horizontal top of the center console 2 is shown. In this embodiment, the center console 2 has a bowl-shaped, cylindrical depression that forms a container receptacle 3. In contrast to what is shown here, the container receptacle 3 can also be installed in the center console 2 as a separate part. The container receptacle 3 is open at the top and has a base 4 at the bottom.

On the base 4, there is another base 5 that will be referred to below as the detachable base 5. In order to make a distinction, the base 4, which is formed in a single piece with the container receptacle 3, is referred to as the fixed base 4. The detachable base 5 lies on the fixed base 4 and inside the container receptacle 3. It can be removed from the container receptacle 3, which is why it is referred to as detachable. The detachable base 5 has an encircling rim 6 that extends upwards, as a result of which it is configured as a drip tray 7. The detachable base 5, configured as a drip tray 7, collects liquid that spills out of the beverage container and ends up in the container receptacle 3. Since the detachable base 5 can be easily removed from the container receptacle 3, it can be easily cleaned.

The detachable base 5 has four spring elements 8 that are formed in one piece with the detachable base 5, that extend upwards and that are arranged offset to each other by 90° along the circumference. The spring elements 8 are in the form of leaf springs curved inwards. Their free, upper ends form resilient holding jaws 9 that are resilient towards the inside into the container receptacle 3 and that can be pressed outwards against the spring force of the spring elements 8. At their free, upper ends, the spring elements 8 have resilient curved pieces 10 that extend outwards and that make a transition back into the leaf-like spring elements 8 at about half the height of the latter. The resilient curved pieces 10 are formed in a single piece with the spring elements 8. The tops of the resilient curved pieces 10 run from the free, upper ends of the spring elements 8 obliquely upwards and outwards with respect to the container receptacle 3. The tops that run obliquely upwards/outwards form pressing surfaces 11 that serve to press the holding jaws 9 away towards the outside.

The resilient curved pieces 10 lie in grooves 12 that project outwards from an encircling wall 13 of the container receptacle 3. The grooves 12 have a rectangular cross section, they are open inwards towards the container receptacle 3 and they have a curved groove base 14 that runs outwards/upwards. The resilient curved pieces 10 are supported towards the outside on the groove base 14, as a result of which the spring force of the spring elements 8 is increased. The grooves 12 guide the resilient curved pieces 10 and, via the grooves 12, the spring elements 8 with the holding jaws 9 are guided in the lateral direction, so that the spring elements 8 with the holding jaws 9 can move resiliently essentially only radially to the container receptacle 3, and are secured against a movement in the tangential direction of the container receptacle 3.

At the open top of the container receptacle 3, there is a ring-shaped collar 15 whose opening is as large as the diameter of the container receptacle 3 and which is flush with the top of the center console 2. The collar 15 covers the top of the grooves 12 that are open on the top.

When a beverage container, for instance, the bottle shown in FIG. 1, is placed into the holder 1 according to the invention, the bottom of the bottle comes into contact with the pressing surfaces 11 of the holding jaws 9 that run obliquely outwards/upwards and with the spring elements 8. The bottom of the bottle presses the holding jaws 9 outwards against the spring force of the spring elements 8 and of the resilient curved pieces 10 that are supported towards the outside on the groove bases 14 so that the bottle can be placed into the container receptacle 3. The spring elements 8 and the resilient curved pieces 10 press the holding jaws 9 inwards, that is to say, from the outside against the bottle that has been placed there, so that the bottle is held in the beverage container 3 of the holder 1 in such a way that it cannot tip over.

After the collar 15 has been removed, the detachable base 5 can be taken out of the container receptacle 3 together with the spring elements 8, the holding jaws 9 and the resilient curved pieces 10, so as to clean, for example, liquid that has ended up in the container receptacle 3. As described above, the detachable base 5 is configured as a drip tray 7 and it collects liquid that has ended up in the container receptacle 3.

As an alternative, the collar 15 could also be formed in a single piece with the center console 2 or with the container receptacle 3 if the detachable base 5 and especially the resilient curved pieces 10 are made of an appropriate material, for instance, a thermoplastic elastomer. In this case, the holding jaws 9 can be bent inwards to such an extent that the base 5 can be removed and put back once again.

Moreover, the base 5 can be additionally latched onto the container receptacle 3 in order to prevent the base 5 from being partially lifted out when a beverage container with a particularly large diameter is removed.

### LIST OF REFERENCE NUMERALS

1 holder

2 center console

3 container receptacle

4 fixed base

5 detachable base

6 rim

7 drip tray

8 spring element

9 holding jaw

10 resilient curved pieces

11 pressing surface

12 groove

13 encircling wall

14 groove base

15 collar

What is claimed is:

1. A holder for a beverage container, the holder comprising:
a container receptacle configured to receive a beverage container;
a separate base disposed in the container receptacle; and
at least one holding jaw formed in a single piece with the base, the at least one holding jaw being inwardly resilient and pressable toward an outside of the container receptacle.

2. The holder recited in claim 1, wherein the base is detachable from the container receptacle.

3. The holder recited in claim 1, wherein the at least one holding jaw includes a plurality of holding jaws disposed about a circumference of the holder.

4. The holder recited in claim 1, wherein the base includes a drip tray.

5. The holder recited in claim 1, further comprising a spring element disposed in a circumferential area of the container receptacle and extending upward from the base, the spring element being formed in a single piece with the at least one holding jaw and the base.

6. The holder recited in claim 1, wherein the holding jaw includes a spring element having an outer side that is supported on the container receptacle.

7. The holder recited in claim 1, wherein the holding jaw includes a spring element having a resilient curved piece.
